(19) United States
(12) Patent Application Publication
(10) Pub. No.: US 2007/0011946 A1
(43) Pub. Date: Jan. 18, 2007

(54) Automatically operated windows

(76) Inventors: Timothy P. Mullen, Marshfield, MA (US); George K. Bezanson III, Cape Coral, FL (US); Christopher J. Kyricos, Cohasset, MA (US); Ken Vachon, Holliston, MA (US)

Correspondence Address: KRISTOFER E. ELBING, 187 PELHAM ISLAND ROAD, WAYLAND, MA, 01778, US

(21) Appl. No.: 11/322,162

(22) Filed: Dec. 28, 2005

Related U.S. Application Data
(60) Provisional application No. 60/699,014, filed on Jul. 13, 2005.

(51) Int. Cl. E05F 11/00

(52) U.S. Cl. 49/325

(57) ABSTRACT

Double-hung window actuators exhibiting one or more of several beneficial features are disclosed. They can include bidirectional linear drive mechanisms sized to fit at least partially inside channels defined at least in part by the jamb runs of a movable sash. These drive mechanisms can be built around a right mounting support of adequate stiffness to support the mechanism independent of external support. Sash pin interfaces can interact with sash pins on the window. Actuation load sensors can detect changes in loading of the actuators, and an edge sensor can be electrically connected to the drive mechanisms. The actuators can be housed in a housing that includes a window apron for mounting below the window.

### CROSS-REFERENCE TO RELATED APPLICATION

This application claims the benefit of U.S. Provisional Application No. 60/699,014, filed Jul. 13, 2005, which is herein incorporated by reference.

### FIELD OF THE INVENTION

This invention relates to automating double-hung windows to allow them to be operated more easily.

### BACKGROUND OF THE INVENTION

Numerous approaches to automating double-hung windows have been proposed in the last century. These typically involve the addition of a motor and an actuating mechanism to a double-hung window. But although double-hung windows are very common, and motorized accessories are now readily available for skylights, casement windows, and greenhouses, none of the approaches proposed for residential double-hung windows appears to be in widespread use at this time.

### SUMMARY OF THE INVENTION

In one general aspect, the invention features a double-hung window actuator for a double-hung window that includes a movable sash with a left stile that cooperates with a left jamb run that extends from its bottom rail to its top rail on its left edge, and a right stile that cooperates with a right jamb run that extends from its bottom rail to its top rail on its right edge. The window actuator includes an actuation unit, a left sash interface, and a right sash interface. A left bidirectional linear drive mechanism is operatively connected between the actuation unit and the left sash interface, with the right linear drive mechanism being sized to fit at least partially inside a left channel defined at least in part by the left jamb run of the movable sash. A right bidirectional linear drive mechanism operatively connected between the actuation unit and the right sash interface, with the right linear drive mechanism being sized to fit at least partially inside a right channel defined at least in part by the right jamb run of the movable sash.

In preferred embodiments, the left sash interface can include a hole sized to cooperate with a left sash pin in the left stile at the bottom rail and the right sash interface can include a hole sized to cooperate with a right sash pin in the left stile at the bottom rail. The holes can be keyed. The window actuator can further include at least one biasing mechanism positioned to assist the action of the actuation unit in at least one direction. The biasing mechanism can include a left spring operatively connected between a left fixed location and the movable sash and a right spring operatively connected between a right fixed location and the movable sash. The window actuator can further include a left block-and-tackle and a right block-and-tackle, with the left spring and the left block-and-tackle being operatively connected between the left fixed location and the movable sash and the right spring and the right block-and-tackle being operatively connected between a right fixed location and the movable sash. A first end of the left spring can be operatively connected to the left fixed location, with a second end of the left spring being operatively connected to a first end of the left block-and-tackle, with a second end of the left block-and-tackle being operatively connected to the left sash interface, with a first end of the right spring being operatively connected to the right fixed location, with a second end of the right spring being operatively connected to a first end of the right block-and-tackle, and with a second end of the right block-and-tackle being operatively connected to the right sash interface. The double-hung window can be a standard window that is designed for use without the actuator. The double-hung window actuator can be constructed and adapted to allow the double-hung window to retain its own biasing mechanism. The double-hung window actuator can be constructed and adapted to allow the double-hung window to retain its own sash pins. The left drive mechanism can include a left chain that runs through at least a part of the left drive mechanism and the right drive mechanism can include a right chain that runs through at least a part of the right drive mechanism. The left drive mechanism can include a left cable that runs through at least a part of the left drive mechanism and the right drive mechanism can include a right cable that runs through at least a part of the right drive mechanism. At least part of one of the left drive mechanism and the right drive mechanism can be electrically insulating. The left run and the right run each can have a cross-section of less than about two square inches. A clutch can be operatively connected between the actuation unit and the left and right drive mechanisms. The actuation unit can include an electric motor, with the double-hung window actuator being constructed and adapted to allow the motor to be located below the double-hung window. The left drive mechanism can include a left shaft between the motor and a left wheel and the right drive mechanism can include a right shaft between the motor and a right wheel. The left drive mechanism can be a left two-wheel-and-loop mechanism and can further include a left mounting support for mounting both of its wheels, and the right drive mechanism can be a right two-wheel-and-loop mechanism and can further include a right mounting support for mounting both of its wheels. The left mounting support and the right mounting support can be angled metal mounting supports. The left mounting support and the right mounting support can have a C-shaped profile. The left drive mechanism can be supported by a left mounting support and the right drive mechanism can be supported by a right mounting support. The window can further include a movably mounted apron located below the double-hung window to house the actuation unit while allowing access to the actuation unit. The window actuator can further include a programmable controller operatively electrically connected to the actuation unit. The right linear drive mechanism can be sized to fit substantially completely inside the left jamb run of the movable sash, and the right linear drive mechanism can be sized to fit substantially completely inside the right jamb run of the movable sash. The movable sash can be a lower sash.

In another general aspect, the invention features a double-hung window actuator for a double-hung window that includes a first sash, and a movable second sash. The window actuator includes an actuation unit, a left sash interface, and a right sash interface. A unitary left bidirectional linear drive mechanism is operatively connected between the actuation unit and the left sash interface, with the right linear drive mechanism being built around a right mounting support of adequate stiffness to support the mechanism independent of external support. A unitary right bidirectional linear drive mechanism is operatively connected between the actuation unit and the right sash interface, with the right linear drive mechanism being built around a right mounting support of adequate stiffness to support the mechanism independent of external support. In preferred embodiments, the left drive mechanism can be a left two-wheel-and-loop mechanism, with both of its wheels mounted in the left mounting support, and the right drive mechanism can be a right two-wheel-and-loop mechanism with both of its wheels mounted in the right mounting support.

In a further general aspect, the invention features a double-hung window actuator for a double-hung window that includes a movable sash with a left sash pin at a left side of its bottom rail and a right sash pin at a right side of its bottom rail. The window actuator includes an actuation unit, a left sash pin interface operative to interact with the left sash pin, and a right sash pin interface operative to interact with the left sash pin. A left bidirectional linear drive mechanism is operatively connected to the actuation unit and the left sash pin interface, and a right bidirectional linear drive mechanism is operatively connected between the actuation unit and the right sash pin interface. In preferred embodiments, The left sash pin can include a stem with at least one flat, with the left bidirectional linear drive mechanism including a keyed hole operative to accept the left sash pin, and the right sash pin can include a stem with at least one flat, with the right bidirectional linear drive mechanism including a keyed hole operative to accept the right sash pin.

In another general aspect, the invention features a double-hung window actuator for a double-hung window that includes a first sash, and a movable second sash. The window actuator includes an actuation unit, a left sash interface, and a right sash interface. A left bidirectional linear drive mechanism is operatively connected to the actuation unit and the left sash interface, and a right bidirectional linear drive mechanism operatively connected between the actuation unit and the right sash interface. An actuation load sensor is responsive to the actuation unit and is operative to detect changes in loading of the actuator, with the actuation load sensor having an actuation unit disabling output provided to the actuation unit. In preferred embodiments, the actuation unit can be an electric motor and wherein the actuation load sensor is an electrical load sensor.

In a further general aspect, the invention features a double-hung window actuator for a double-hung window that includes a first sash, and a movable second sash. The window actuator includes an actuation unit, a left sash interface, and a right sash interface. An edge sensor is located at a distal edge of a bottom rail of the second sash and has a first pole and a second pole. A left bidirectional linear drive mechanism is operatively connected to the actuation unit and the left sash interface and has at least one conductive portion operatively electrically connected to the first pole of the edge sensor, and a right bidirectional linear drive mechanism is operatively connected between the actuation unit and the right sash interface and has at least one conductive portion operatively electrically connected to the second pole of the edge sensor. The conductive portion of the first linear drive mechanism is electrically isolated from the conductive portion of the second linear drive mechanism.

In another general aspect, the invention features a window actuator housing that includes a window apron for mounting below the window and in front of the window actuator. The housing also includes a removable mounting mechanism for the window apron and includes a first interface operatively connected to the apron, and a second interface for mounting on a wall surface below the window.

The movable mounting mechanism can include a hinge, with the interfaces being screws that each pass through a screw hole in one of two parts of the hinge. The movable mounting mechanism can include a keyed closure mechanism that requires a non-standard tool.

In a further general aspect, the invention features a double-hung window installation method that includes the steps of providing a double-hung window assembly including channels that run at least generally parallel to stiles of a movable sash of the double hung window, providing an actuation mechanism in each of the channels, and installing the window in a rectangular rough opening.

In preferred embodiments, the method can further include a step of removing the window from the rough opening before the step of providing a double-hung window. The step of providing a double-hung window can provide a window that is designed to operate manually. The channel can be a biasing mechanism channel. The method can further include step of removing an existing biasing mechanism from the channel before the step of providing an actuation mechanism in each of the channels. The method can further include the step of reinstalling the existing biasing mechanism with the actuation mechanism. The method can further include the step of installing at least a part of the actuation mechanism below the window behind a removable apron. The step of installing at least a part of the actuation mechanism below the window can install it behind a hinged apron. The step of installing at least a part of the actuation mechanism below the window can install it behind an apron mounted with screws that require a non-standard removal tool. The step of providing actuation mechanisms can include providing unitary mechanical actuation mechanisms each built around a mounting support. The step of providing actuation mechanisms can include inserting them into the channels along the longitudinal axes of the channels.

The invention can provide a simple, straightforward mechanism for automatically opening double-hung windows. Because it can allow for installation in a channel of an existing window, it can be used in a variety of window models using a simple rectangular rough opening. And by providing for a movable service apron for hiding parts of the actuation mechanism, the installed window can be made to look much like an ordinary window.

Mechanisms according to the invention can be installed in new buildings and retrofit onto existing windows without significant modifications to the window or framing around the window. Buildings such as nursing homes can thus be fitted with automatic windows using conventional building techniques. And elderly, incapacitated, or infirm individuals can cost-effectively automate one or more windows in their existing homes.

### BRIEF DESCRIPTION OF THE DRAWING

FIG. 1 is a perspective diagram of an automatic window according to the invention;

FIG. 2 is a perspective diagram of an actuation mechanism for the window of FIG. 1;

FIG. 3 is a right side elevation diagram of a portion of the actuation mechanism of FIG. 1;

FIG. 4A is a top view of a right sash pin installed on a movable sash of the window of FIG. 1;

FIG. 4B is a cross-section of the right sash pin of FIG. 4A in plane defined by lines 4B-4B in FIG. 4A;

FIG. 5A is a simplified perspective diagram of the window of FIG. 1 in its finished installed position showing its actuator compartment in a closed position; and

FIG. 5B is a simplified perspective diagram of the window of FIG. 1 in its finished installed position showing its actuator compartment in an open position;

FIG. 6 is an electrical block diagram for the window of FIG. 1;

FIG. 7 is a top-down cross-sectional view of the window of FIG. 1 with trim and in the plane defined by lines 7-7 in FIG. 5B; and

FIG. 8 is an elevation view of the window of FIG. 1 equipped with a safety switch.

### DETAILED DESCRIPTION OF AN ILLUSTRATIVE EMBODIMENT

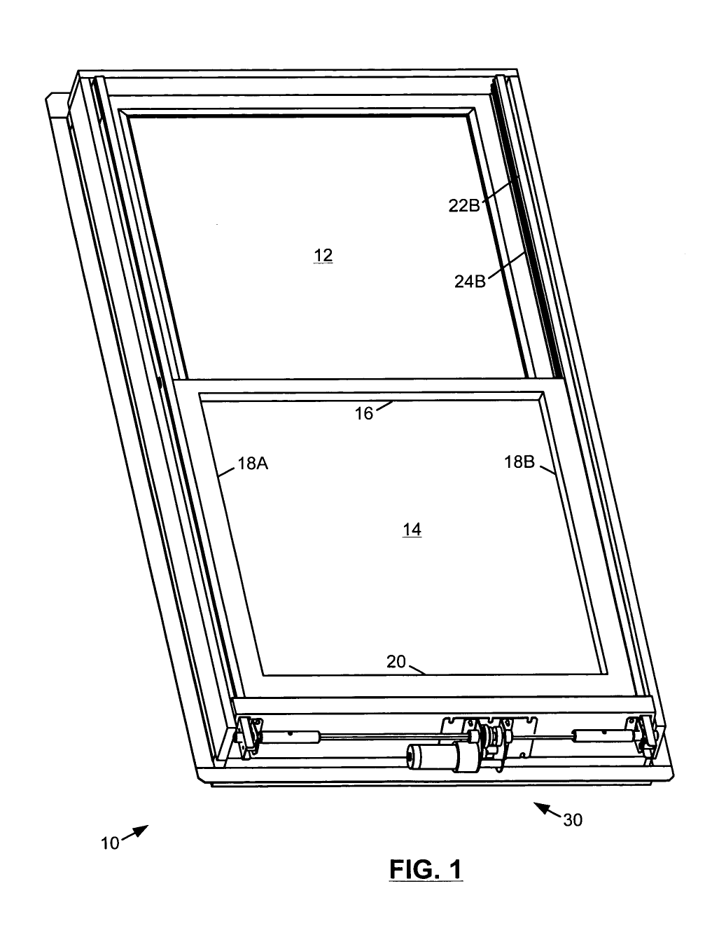

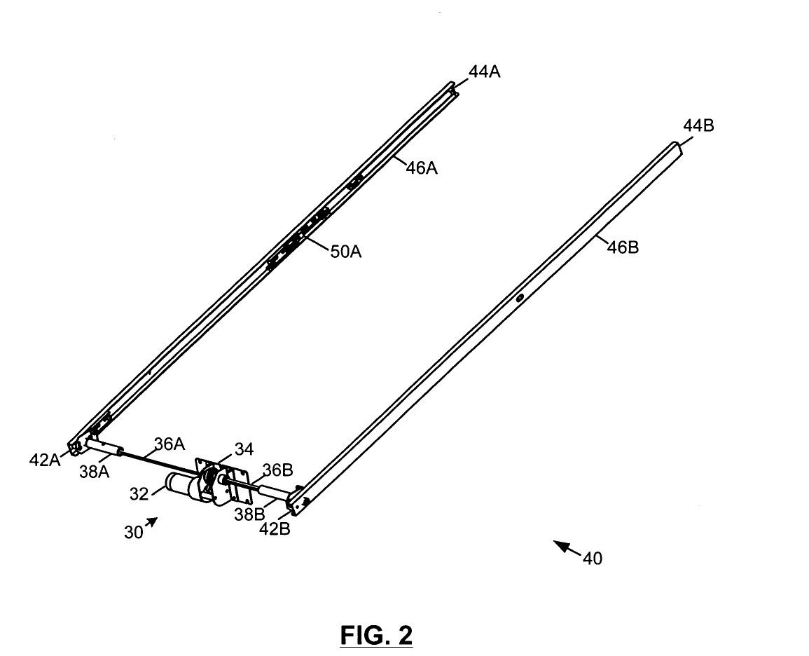

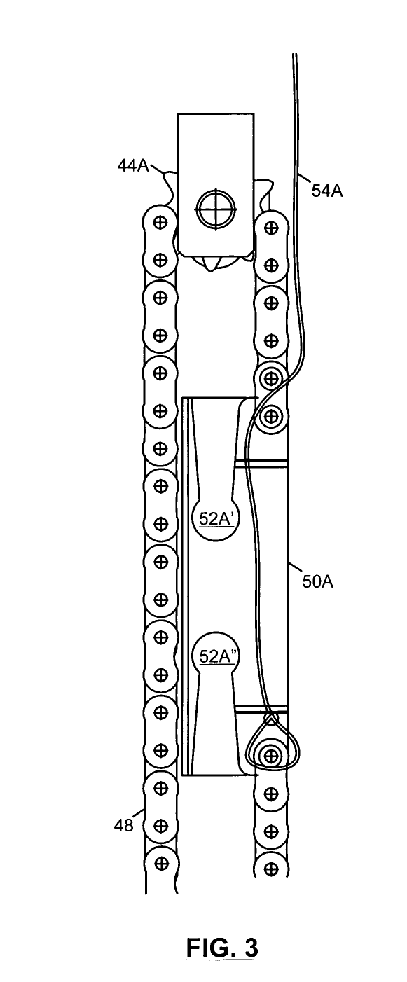

Referring to FIGS. 1-4, an illustrative automated double-hung window 10 according to the invention includes a top sash 12 and a bottom sash 14. As is conventional, each sash includes a top rail 16, a left stile 18A, a right stile 18B, and a bottom rail 20 which together define a frame for one or more panes of glass. The top and/or bottom sashes are slidably mounted in cooperation with vertically running guide surfaces in a conventional jamb liner 24. In this illustrative embodiment, the top sash is fixed and the bottom sash is automated, but in other embodiments either or both of the sashes could be automated.

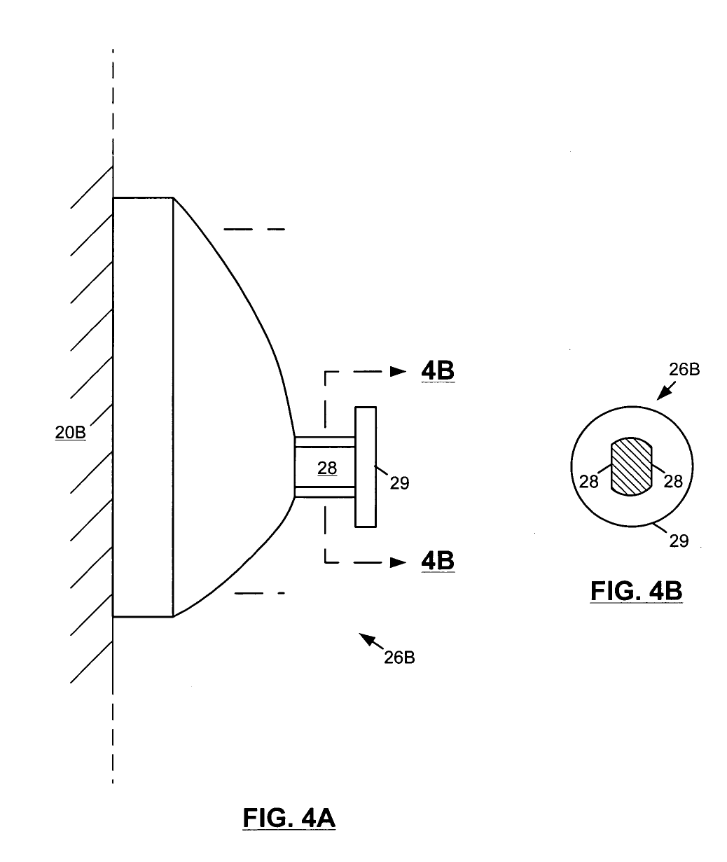

A left sash pin 26A is located on the left stile 20A of the moving sash 14, and a right sash pin 26B is located on the right stile 20B of the moving sash. These two sash pins are typically located near the bottom of the sash and face outward in a direction parallel to or coextensive with a plane defined by the glass pane(s) in the moving sash. As shown in FIGS. 4A and 4B, each sash pin includes a stem that can include a pair of lengthwise flats 28 and an outward end cap 29. This type of sash pin design is common, but differently configured pins could also be used in connection with some embodiments of the invention. And although the use of sash pins is the currently preferred method to interface with the window, other types of mechanisms could also be used for this purpose.

An actuation mechanism 40 for the window includes a pair of mounting supports 26 mounted in the jamb liner 24. Each of these mounting supports holds a bottom sprocket 42, a top sprocket 44, and a chain loop 48 that wraps around the sprockets. The mounting supports are designed to be compact while providing significant strength to the actuation mechanism. They are preferably implemented as a pair of c-channels fashioned by bending steel sheet stock, but other types of supports could also be used.

A carriage 50 is linked to the chain loop, such as by pinning. It defines a first sash pin slot 52′ that interfaces with a corresponding sash pin. This slot is preferably keyed to hold the pin when the moving sash is installed in the window. In this embodiment, keying is accomplished by defining the slot to include a round area with an opening above it that is smaller than its diameter.

The carriage 50 can be made using suitably bent and cut steel sheet stock, or in a variety of other ways. In this embodiment, the carriage also includes a second sash pin slot 52″ that is symmetrically arranged below the first. This allows the same carriage part to be used as a left carriage 50A or a right carriage 50B.

A tether 54 or the like is preferably provided to connect the carriage to a biasing mechanism, such as a spring and block-and-tackle, or a counterweight. This biasing mechanism assists the motor in raising the movable sash, and can be located above the top sprocket 44. Where the actuation mechanism is installed or retrofitted on an existing window, an existing biasing mechanism designed for the window can be used.

An actuator assembly 30 is located below the window. It includes a motor 32 that has an output shaft coupled to an input of a slip clutch 34. The slip clutch has a left output shaft 36A and a right output shaft 36B. The left output shaft 36A is coupled to a left coupling 38A, and the right output shaft 36B is connected to a right coupling 38B. The left coupling is connected to the lower left sprocket 42A, and the right coupling is connected to the lower right sprocket 42B.

The motor 32 is preferably an electric motor, but other types of motive elements could also be used, such as ones based on pneumatics or hydraulics. And in some situations, one motor could be used to drive more than one sash, such as in the case of adjacent windows on a same wall.

As shown in FIG. 6, a current monitoring circuit 72 can be provided between the motor 32 and its power supply 70. This function can be provided in an integrated module that also performs other control functions for the window.

The output shafts 36A, 36B can be square and cooperate with square holes in the sprockets and clutch. This can help to guide the assembly of the actuation mechanism 40 in such a way as to ensure that the left and right carriages 50A, 50B are mechanically in phase. It can also help to prevent later slippage that might alter this relationship. It should also be noted, however, that the actuation mechanism as presented exhibits some tolerance for slippage.

Chain-and-sprocket drive is currently the preferred basis for the actuation mechanism. But other types of linear drive mechanisms could also be employed. These can include other types of wheel-and-loop mechanisms, such as mechanisms that are based on cables and pulleys, with so-called aircraft cables or mechanical tape available from Dymetrol Company, Inc. being preferred. And other types of linear mechanisms such as linkages, lead screws, cogs, or pistons could also be usable in connection with some embodiments of the invention.

In operation, the movable sash 14 is installed by holding it horizontally and placing each of the sash pins 26A, 26B above a respective opening in the upper sash pin slots 52A′, 52B′. In this position, the flats 28 of the pin stems will be oriented vertically, allowing them to drop into the openings in the sash pin slots. The window is then pivoted about the pins into its ordinary upright position. In this position, the flats of the sash pin stems will be oriented horizontally, locking the pins in the respective sash pin slots.

When the movable sash 14 is in its bottom position and its motor 32 receives power from a switch or controller, the motor turns the output shafts 36A, 36B through the slip clutch 34. The left output shaft 36A turns the left coupling 38A and the left bottom sprocket 42A. At the same time, the right output shaft 36B turns the right coupling 38A and the right bottom sprocket 42A. This causes the left chain loop 48A to pull the left carriage 50A up the left mounting support, and the right chain loop 48B to pull the right carriage 50B up the right mounting support. The lower inside edges of the sash pin slots 52 in the rising carriages will bear against the sash pins 26 and lift the window from both sides.

The motor 32 will continue to open the window until it reaches an obstruction or the motor is powered off. If the window reaches an obstruction that the motor cannot overcome without exceeding the rated slip torque of the slip clutch, the slip clutch will disengage the motor from the output shafts 36A, 36B. This will cause the window to stop rising, because of the friction inherent in the window's operation, and the motor will begin running at a higher no load speed. Preferably, the current monitoring circuit 72 will detect this increase in the motor speed and power it down. In the present embodiment, this current-based approach is also used to cause the sash to stop at the top of its range, although limit switches or other stopping systems could also be used.

Reversing the direction of operation of the motor, such as by reversing the polarity of the supply voltage in the case of a DC motor, causes the carriages 50A, 50B to move downward. Because of the weight of the window and/or because the sash pins are locked into the sash pin slots 52A′, 52B′, the carriages will pull the sash back down toward its bottom closed position. And it will continue moving in that direction until the motor is stopped, or the slip clutch disengages.

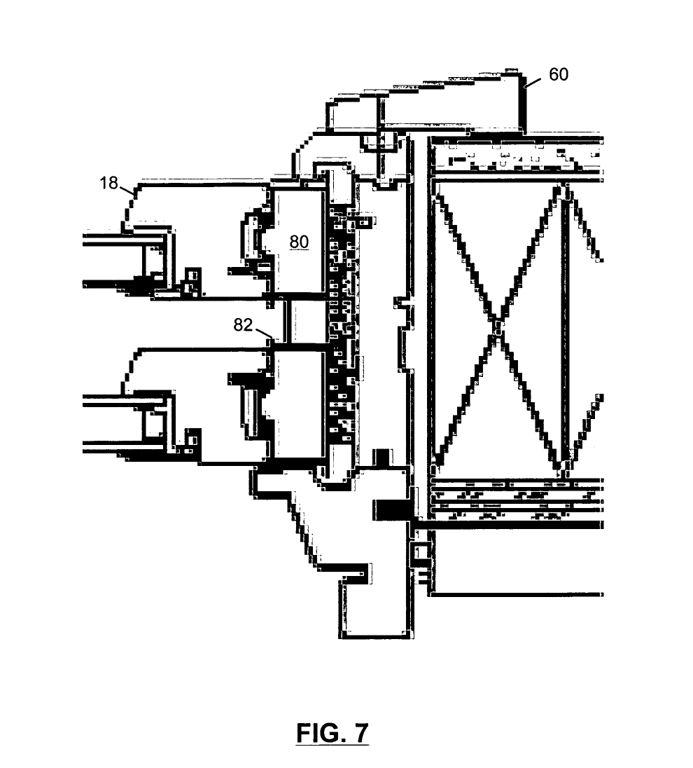

Referring to FIG. 7, a preferred embodiment of the invention is designed to fit one or more off-the-shelf, non-automated window models. It is installed by placing the support assemblies in a channel 80 that is defined by the jamb run 82 and/or the stile 18 and which the biasing mechanism normally occupies, at least in part. The actuation assembly is mounted on the bottom of the window sill and holes for the chain and support are also provided in the sill. The existing biasing mechanism, or a new one, can be attached to the carriage. It should be noted that while the jamb run 82 shown defines two channels that are normally used for a biasing mechanism, other jamb run configurations could also work in connection with the invention. For example, surfaces of the stile could define part of the channel, the channel could be of a different shape, or the channel could extend only part of the way up the window.

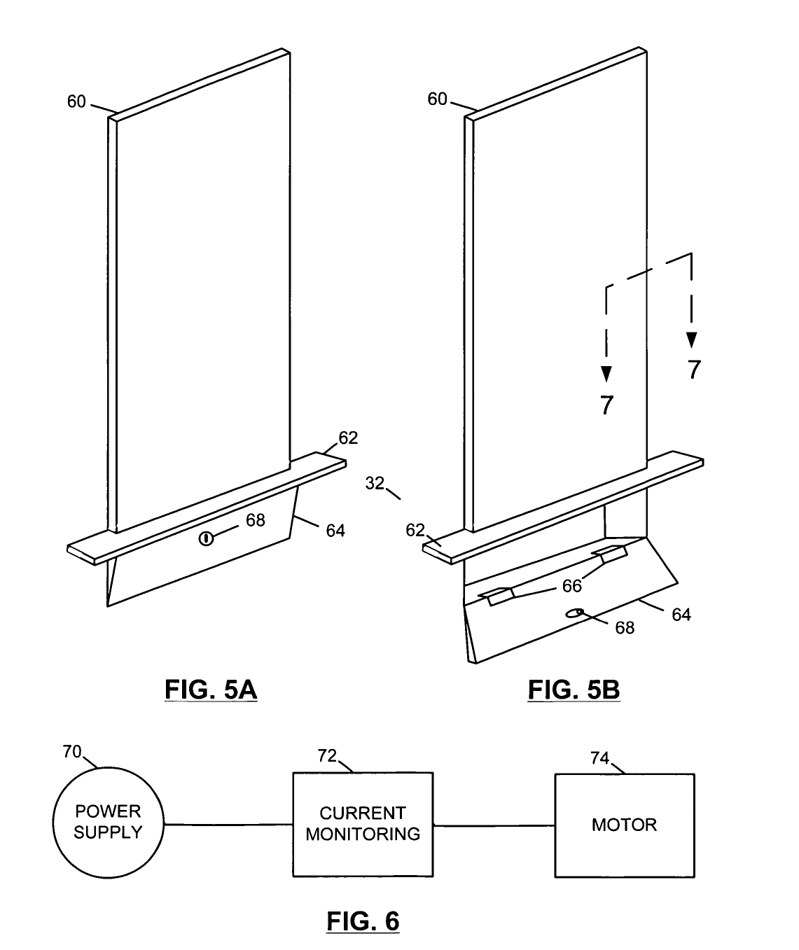

Referring to FIGS. 1 and 5, the actuator assembly 30 is preferably located in a compartment below the window behind a decorative apron 64. This apron can be designed to look like a conventional decorative apron, which can take the form of a trim board that extends most or substantially all of the way below the sill. Some or all of the apron can also be tapered away from the window in one or more directions.

The apron is preferably installed in a removable or semi-permanent manner, such as with hinges 66, to allow relatively easy access to the actuator assembly for service and repair. The apron should not be too easy to open, however, to prevent inappropriate access, such as access by children. The desired level of accessibility can be achieved in a variety of ways, such as through the use of a keyed access mechanism 68 or through semi-permanent installation of the apron with screws, which can also be keyed. The remaining outside and inside trim 60 around the window can be conventional.

The automated double-hung window 10 can be installed as a new item or retrofit using existing windows. In a new installation, a rough opening is prepared to accept the window as it normally would, except that the opening is made to extend somewhat lower to allow room for the actuator assembly 30A (e.g., by two inches). The window can then be installed in the rough opening, much as it would be if it were not automated. It can then be wired for remote operation. In a retrofit application, the window is removed and its rough opening is extended. The actuation mechanism can then be added to the window in the field, and the window can be reinstalled, as described above. Although it is currently preferred to build automated windows by equipping off-the-shelf windows with an actuation mechanism, it is also possible to build a dedicated automated window based on the teachings of this invention.

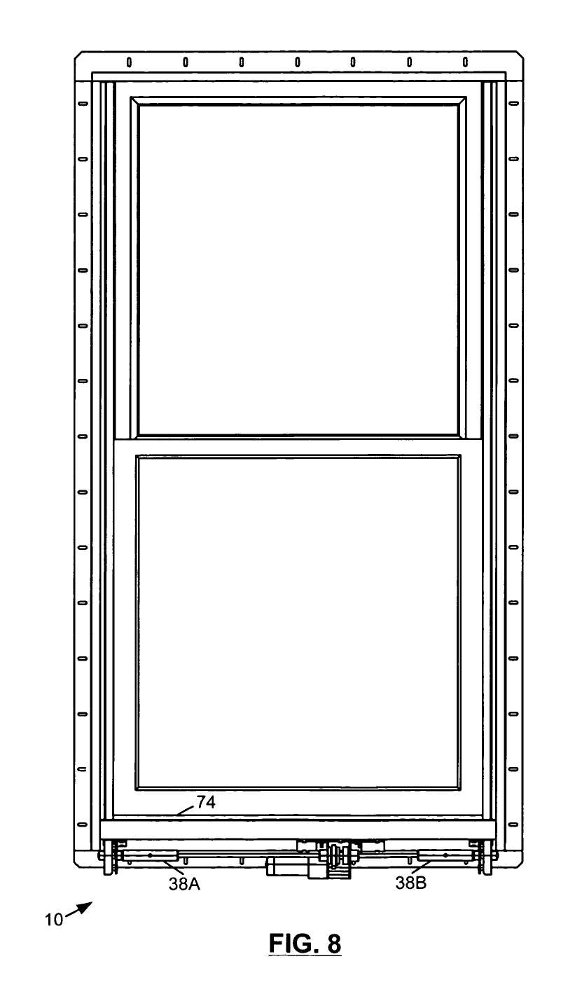

Referring to FIG. 8, the automated double-hung window 10 can also be outfitted with a safety switch 74. This safety switch is made with a conventional electrical edge switch that is screwed or glued to the bottom edge of the lower rail 20. Because of the isolating couplings 38, the two leads of the safety switch can be connected to respective sash pins. This allows metal parts of the actuation mechanism themselves to connect the switch to a detection circuit, instead of requiring there to be addition wiring that could add expense and complexity.

The present invention has now been described in connection with a number of specific embodiments thereof. However, numerous modifications which are contemplated as falling within the scope of the present invention should now be apparent to those skilled in the art. Therefore, it is intended that the scope of the present invention be limited only by the scope of the claims appended hereto. In addition, the order of presentation of the claims should not be construed to limit the scope of any particular term in the claims.

What is claimed is:

1. A double-hung window actuator for a double-hung window that includes a movable sash with a left stile that cooperates with a left jamb run that extends from its bottom rail to its top rail on its left edge, and a right stile that cooperates with a right jamb run that extends from its bottom rail to its top rail on its right edge, comprising:
an actuation unit,
a left sash interface,
a right sash interface,
a left bidirectional linear drive mechanism operatively connected between the actuation unit and the left sash interface, wherein the right linear drive mechanism is sized to fit at least partially inside a left channel defined at least in part by the left jamb run of the movable sash, and
a right bidirectional linear drive mechanism operatively connected between the actuation unit and the right sash interface, wherein the right linear drive mechanism is sized to fit at least partially inside a right channel defined at least in part by the right jamb run of the movable sash.

2. The double-hung window actuator of claim 1 wherein the left sash interface includes a hole sized to cooperate with a left sash pin in the left stile at the bottom rail and wherein the right sash interface includes a hole sized to cooperate with a right sash pin in the left stile at the bottom rail.

3. The double-hung window actuator of claim 2 wherein the holes are keyed.

4. The double-hung window actuator of claim 1 further including at least one biasing mechanism positioned to assist the action of the actuation unit in at least one direction.

5. The double-hung window actuator of claim 4 wherein the biasing mechanism includes a left spring operatively connected between a left fixed location and the movable sash and a right spring operatively connected between a right fixed location and the movable sash.

6. The double-hung window actuator of claim 5 further including a left block-and-tackle and a right block-and-tackle, and wherein the left spring and the left block-and-tackle are operatively connected between the left fixed location and the movable sash and the right spring and the right block-and-tackle are operatively connected between a right fixed location and the movable sash.

7. The double-hung window actuator of claim 6 wherein a first end of the left spring is operatively connected to the left fixed location, wherein a second end of the left spring is operatively connected to a first end of the left block-and-tackle, wherein a second end of the left block-and-tackle is operatively connected to the left sash interface, wherein a first end of the right spring is operatively connected to the right fixed location, wherein a second end of the right spring is operatively connected to a first end of the right block-and-tackle, and wherein a second end of the right block-and-tackle is operatively connected to the right sash interface.

8. The double-hung window actuator of claim 1 wherein the double-hung window is a standard window that is designed for use without the actuator.

9. The double-hung window actuator of claim 8 wherein the double-hung window actuator is constructed and adapted to allow the double-hung window to retain its own biasing mechanism.

10. The double-hung window actuator of claim 8 wherein the double-hung window actuator is constructed and adapted to allow the double-hung window to retain its own sash pins.

11. The double-hung window actuator of claim 1 wherein the left drive mechanism includes a left chain that runs through at least a part of the left drive mechanism and the right drive mechanism includes a right chain that runs through at least a part of the right drive mechanism.

12. The double-hung window actuator of claim 11 wherein the left drive mechanism includes a left cable that runs through at least a part of the left drive mechanism and the right drive mechanism includes a right cable that runs through at least a part of the right drive mechanism.

13. The double-hung window actuator of claim 1 wherein at least part of one of the left drive mechanism and the right drive mechanism is electrically insulating.

14. The double-hung window actuator of claim 1 wherein the left run and the right run each have a cross-section of less than about two square inches.

15. The double-hung window actuator of claim 1 further including a clutch operatively connected between the actuation unit and the left and right drive mechanisms.

16. The double-hung window actuator of claim 1 wherein the actuation unit includes an electric motor and wherein the double-hung window actuator is constructed and adapted to allow the motor to be located below the double-hung window.

17. The double-hung window actuator of claim 16 wherein the left drive mechanism includes a left shaft between the motor and a left wheel and the right drive mechanism includes a right shaft between the motor and a right wheel.

18. The double-hung window actuator of claim 1 wherein the left drive mechanism is a left two-wheel-and-loop mechanism and further including a left mounting support for mounting both of its wheels, and wherein the right drive mechanism is a right two-wheel-and-loop mechanism and further including a right mounting support for mounting both of its wheels.

19. The double-hung window actuator of claim 18 wherein the left mounting support and the right mounting support are angled metal mounting supports.

20. The double-hung window actuator of claim 19 wherein the left mounting support and the right mounting support have a C-shaped profile.

21. The double-hung window actuator of claim 1 wherein the left drive mechanism is supported by a left mounting support and the right drive mechanism is supported by a right mounting support.

22. The double-hung window actuator of claim 21 wherein the left mounting support and the right mounting support are angled metal mounting supports.

23. The double-hung window actuator of claim 22 wherein the left mounting support and the right mounting support have a C-shaped profile.

24. The double-hung window actuator of claim 1 further including a movably mounted apron located below the double-hung window to house the actuation unit while allowing access to the actuation unit.

25. The double-hung window actuator of claim 1 further including a programmable controller operatively electrically connected to the actuation unit.

26. The double-hung window actuator of claim 1 wherein the right linear drive mechanism is sized to fit substantially completely inside the left jamb run of the movable sash, and wherein the right linear drive mechanism is sized to fit substantially completely inside the right jamb run of the movable sash.

27. The double-hung window actuator of claim 1 wherein the movable sash is a lower sash.

28. A double-hung window actuator for a double-hung window that includes a first sash, and a movable second sash, comprising:
an actuation unit,
a left sash interface,
a right sash interface,
a unitary left bidirectional linear drive mechanism operatively connected between the actuation unit and the left sash interface, wherein the right linear drive mechanism is built around a right mounting support of adequate stiffness to support the mechanism independent of external support, and
a unitary right bidirectional linear drive mechanism operatively connected between the actuation unit and the right sash interface, wherein the right linear drive mechanism is built around a right mounting support of adequate stiffness to support the mechanism independent of external support.

29. The double-hung window actuator of claim 28 wherein the left drive mechanism is a left two-wheel-and-loop mechanism, with both of its wheels mounted in the left mounting support, and wherein the right drive mechanism is a right two-wheel-and-loop mechanism with both of its wheels mounted in the right mounting support.

30. A double-hung window actuator for a double-hung window that includes a movable sash with a left sash pin at a left side of its bottom rail and a right sash pin at a right side of its bottom rail, comprising:
an actuation unit,
a left sash pin interface operative to interact with the left sash pin,
a right sash pin interface operative to interact with the left sash pin,
a left bidirectional linear drive mechanism operatively connected to the actuation unit and the left sash pin interface, and
a right bidirectional linear drive mechanism operatively connected between the actuation unit and the right sash pin interface.

31. The double-hung window of claim 30 wherein the left sash pin includes a stem with at least one flat, wherein the left bidirectional linear drive mechanism includes a keyed hole operative to accept the left sash pin, wherein the right sash pin includes a stem with at least one flat, and wherein the right bidirectional linear drive mechanism includes a keyed hole operative to accept the right sash pin.

32. A double-hung window actuator for a double-hung window that includes a first sash, and a movable second sash, comprising:
an actuation unit,
a left sash interface,
a right sash interface,
a left bidirectional linear drive mechanism operatively connected to the actuation unit and the left sash interface,
a right bidirectional linear drive mechanism operatively connected between the actuation unit and the right sash interface, and
an actuation load sensor that is responsive to the actuation unit and is operative to detect changes in loading of the actuator, wherein the actuation load sensor has an actuation unit disabling output provided to the actuation unit.

33. The double-hung window actuator of claim 32 wherein the actuation unit is an electric motor and wherein the actuation load sensor is an electrical load sensor.

34. A double-hung window actuator for a double-hung window that includes a first sash, and a movable second sash, comprising:
an actuation unit,
a left sash interface,
a right sash interface,
an edge sensor located at a distal edge of a bottom rail of the second sash and having a first pole and a second pole,
a left bidirectional linear drive mechanism operatively connected to the actuation unit and the left sash interface and having at least one conductive portion operatively electrically connected to the first pole of the edge sensor,
a right bidirectional linear drive mechanism operatively connected between the actuation unit and the right sash interface and having at least one conductive portion operatively electrically connected to the second pole of the edge sensor, and
wherein the conductive portion of the first linear drive mechanism is electrically isolated from the conductive portion of the second linear drive mechanism.

35. A window actuator housing, comprising:
a window apron for mounting below the window and in front of the window actuator,
a removable mounting mechanism for the window apron and including:
a first interface operatively connected to the apron, and
a second interface for mounting on a wall surface below the window.

36. The window actuator housing of claim 35 wherein the movable mounting mechanism includes a hinge and wherein the interfaces are screws that each pass through a screw hole in one of two parts of the hinge.

37. The window actuator housing of claim 35 wherein the movable mounting mechanism includes a keyed closure mechanism that requires a non-standard tool.

38. A double-hung window installation method, comprising:
providing a double-hung window assembly including channels that run at least generally parallel to stiles of a movable sash of the double hung window,
providing an actuation mechanism in each of the channels, and
installing the window in a rectangular rough opening.

39. The method of claim 38 further including a step of removing the window from the rough opening before the step of providing a double-hung window.

40. The method of claim 38 wherein the step of providing a double-hung window provides a window that is designed to operate manually.

41. The method of claim 38 wherein the channel is a biasing mechanism channel.

42. The method of claim 41 further including the step of removing an existing biasing mechanism from the channel before the step of providing an actuation mechanism in each of the channels.

43. The method of claim 42 further including the step of reinstalling the existing biasing mechanism with the actuation mechanism.

44. The method of claim 38 further including the step of installing at least a part of the actuation mechanism below the window behind a removable apron.

45. The method of claim 44 wherein the step of installing at least a part of the actuation mechanism below the window installs it behind a hinged apron.

46. The method of claim 44 wherein the step of installing at least a part of the actuation mechanism below the window installs it behind an apron mounted with screws that require a non-standard removal tool.

47. The method of claim 38 wherein the step of providing actuation mechanisms includes providing unitary mechanical actuation mechanisms each built around a mounting support.

48. The method of claim 38 wherein the step of providing actuation mechanisms includes inserting them into the channels along the longitudinal axes of the channels.
